(19) United States
(12) Patent Application Publication
(10) Pub. No.: US 2015/0006242 A1
(43) Pub. Date: Jan. 1, 2015

(54) TECHNIQUES FOR QUANTIFYING THE INTENT AND INTERESTS OF MEMBERS OF A SOCIAL NETWORKING SERVICE

(71) Applicant: Linkedln Corporation, Mountain View, CA (US)

(72) Inventors: Anmol Bhasin, Mountain View, CA (US); Christian Posse, Forster City, CA (US); Wing H. Li, San Jose, CA (US); Kun Liu, Sannyvale, CA (US)

(21) Appl. No.: 13/931,471

(22) Filed: Jun. 28, 2013

(51) Int. Cl. G06Q 30/02; G06Q 50/00

(52) U.S. Cl. CPC G06Q 30/0201; G06Q 50/01
USPC 705/7.29

(57) ABSTRACT

Techniques are described herein for deriving, for each member of a social networking service, a set of metrics representing a measure of the member's intent and interests. For example, a set of member-intent and member-interest scores are derived by detecting which of several applications and services that a particular user interacts with, when the interactions occur, the frequency of the interactions, the particular type of interactions, the nature of the any particular content (e.g., subject matter, topic, etc.) with which the member is interacting, and so forth. The member-intent and member-interest scores are then made available to a wide-variety of applications and services, for example, for use in personalizing various experiences to best suit the intent and interests of each member.

### RELATED APPLICATIONS

The present application claims the benefit of priority of U.S. Provisional Patent Application No. 61/770,628, filed on Feb. 28, 2013, which is incorporated herein by reference in its entirety.

### TECHNICAL FIELD

The present disclosure generally relates to data processing systems. More specifically, the present disclosure relates to methods, systems and computer program products for analyzing and processing a variety of data for the purpose of determining and quantifying a member's intent and a member's interests in connection with how and why the member interacts with a social networking service.

### BACKGROUND

Online or web-based social networking services provide their members with a mechanism for defining, and memorializing in a digital format, their relationships with other people. This digital representation of real-world relationships is frequently referred to as a social graph. As these social networking services have matured, many of the services have expanded the concept of a social graph to enable users to establish or define relationships or associations with any number of entities and/or objects in much the same way that users define relationships with other people. For instance, with some social networking services and/or with some web-based applications that leverage a social graph that is maintained by a third-party social networking service, users can indicate a relationship or association with a variety of real-world entities and objects (e.g., companies, schools, products and services).

In addition to hosting a vast amount of social graph data, many social networking services maintain a variety of personal information about their members. For instance, with many social networking services, when a user registers to become a member, the member is prompted to provide a variety of personal or biographical information, which may be displayed in a member's personal web page. Such information is commonly referred to as member profile information, or simply “profile information,” and when shown collectively, it is commonly referred to as a member's profile. For instance, with some of the many social networking services in use today, the personal information that is commonly requested and displayed as part of a member's profile includes a person's age or birthdate, gender, interests, contact information, residential address (e.g., home town and/or state), the name of the person's spouse and/or family members, and so forth. With certain social networking services, such as some business or professional network services, a member's personal information may include information commonly included in a professional resume or curriculum vitae, such as information about a person's education, the company at which a person is employed, an industry in which a person is employed, a job title or function, an employment history, skills possessed by a person, professional organizations of which a person is a member, and so on.

As web-based social networking services have evolved, the number and nature of applications and services that leverage these social networking services, and the reasons for why members interact with these applications and services, has increased remarkably. For instance, some members use a social networking service to browse and search member profiles to discover and identify other members who, for one reason or another, are of interest. Other member use social networking services to share information with other members who are in their respective network, as defined by a social graph maintained by the social networking service, or others members of a common group. Accordingly, a social networking service may provide its members with a wide variety of different applications, features and functions that enable members to interact with one another, and discover and consume content. With so many different applications, features and functions being offered, and with different members engaging with different applications, features and functions for different purposes, designing a single interface and experience that will appeal equally to all users becomes an extremely difficult, if not impossible, task.

### DESCRIPTION OF THE DRAWINGS

Some embodiments are illustrated by way of example and not limitation in the FIG's. of the accompanying drawings, in which:

FIG. 1A is a diagram illustrating an example of a hierarchical model for modelling a member's intent and interests, consistent with some embodiments of the invention;

FIG. 1B is a diagram illustrating an example of a member matrix for representing various measures of a member's intent and interests, consistent with some embodiments of the invention;

FIG. 2 is a block diagram showing the functional components of a social networking service, including an intent and interest score-generating module for use in determining various member-intent and member-interest scores, consistent with some embodiments of the invention;

FIG. 3 is a flow diagram showing the method operations of a method for determining various member-intent and member-interest scores for a member of a social networking service, consistent with some embodiments of the invention;

FIG. 4 is a user interface diagram showing an example of a user interface (e.g., web page) of a social networking service in which the selection and arrangement of content modules and other user interface elements is determined in part by a member's intent and/or interest scores, consistent with some embodiments of the invention; and

FIG. 5 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for analyzing and processing data for the purpose of determining member-intent and member-interest scores for members of a social networking service. Once the intent and interest scores for a member are determined, the scores are made available to a wide variety of applications and services, thereby enabling those applications and services to be personalized for the member based on the member's various scores. Although various embodiments of the inventive subject matter are illustrated and described in detail, it will be evident to one skilled in the art that the present invention may be practiced without all of the specific details set forth herein.

Consistent with embodiments of the invention, a computer-based social networking service includes a data processing module, referred to herein as an intent and interest score-generating module (or simply “score-generating module”), that uses a variety of input data (e.g., member profile data, social graph data, and member-activity or behavioral data) to derive various member-intent and member-interest scores for members of the social networking service. In general, a member-intent score is a measure of a member's attitude or desire for certain activities, while a member-interest score represents a more granular level of insight into a particular intent of the member. For example, consider a scenario where a particular member of a social networking service is frequently browsing and searching for various job listings that have been posted to a job listing service provided by, or otherwise associated and integrated with, the social networking service. Based on analysis of the particular member's profile and analysis of the particular member's activities and behavior—that is, how the member has interacted with the various applications and services of the social networking service—the particular member may be assigned a high job-seeker intent score. If the job listings that the member has been browsing and searching for are job listings for jobs in the financial services industry and the information technology industry, then the member may be assigned high member-interest scores for these two particular interests—that is, financial services and information technology. Accordingly, the interest scores capture a more granular level of insight into the particular interests of a member, as those interests relate to a particular intent. Consistent with some embodiments, the score-generating module is designed as an open framework that easily allows integration of different models and algorithms for computing the various intent and interest scores, thereby making it easy for developers to add new models, revise existing models, and perform various tests (e.g., A/B testing) on different versions of similar models.

In the many examples provided below, the specific intent types, as well as the various interest types or categories, may be particularly relevant with respect to a social networking service that is aimed at serving career-oriented members and professionals. However, skilled artisans will readily recognize the general applicability of the inventive subject matter to a wide variety of different types of social networking services, and related applications and services. Moreover, the inventive subject matter is applicable in a variety of applications beyond social networking services.

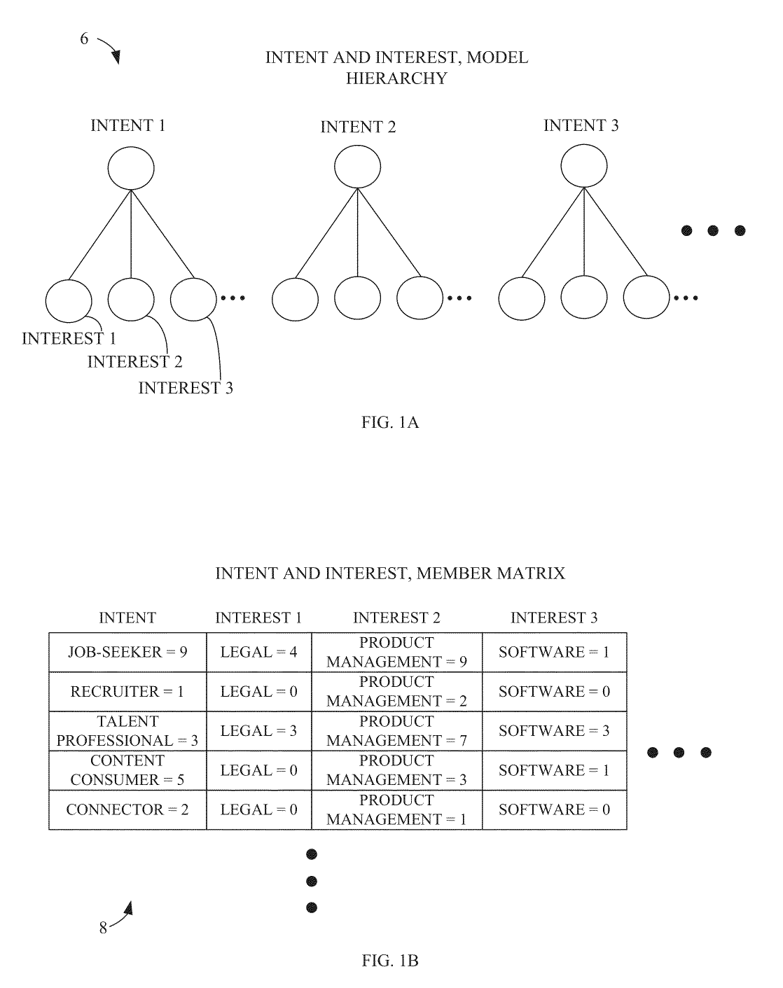

With some embodiments, the score-generating module derives or generates for each member of the social networking service an intent score for each of several intent types or categories. For example, as illustrated in the intent and interest model hierarchy presented in FIG. 1A, each of the model entities labelled with “INTENT 1”, “INTENT 2” and “INTENT 3” represents a different intent type or category. The intent score for each intent type or category is derived using a different algorithm, model or technique, including a unique combination of data inputs. In the context of a professional networking service, these different intent types may include, but certainly are not limited to, the following. A job-seeker intent score may be representative of a member's propensity to change jobs. Accordingly, the job-seeker intent score may indicate a measure of how likely the member is to engage with various applications, services and content that facilitate changing jobs (e.g., such as a job listing service). A recruiter intent score may be representative of a member's propensity to recruit members of the social networking service for various employment positions. Accordingly, the recruiter intent score may indicate a measure of how likely the member is to engage with various applications, services and content that relate to, or otherwise facilitate the recruiting of other members. A talent professional intent score may represent a measure of how likely a member is to subscribe to a particular subscription offering of the social networking service. A content consumer intent score may represent a measure of how likely the member is to consume (e.g., search for, view, and browse) content (e.g., news articles, white papers, blog postings, etc.) published via the social networking service, or some other content provider. Finally, a connector intent score may represent a measure of how likely a member is to connect with other members via the social networking service. With some embodiments, for each member-intent score, several member-interest scores are possible, for different interest types or categories. Accordingly, as shown in FIG. 1B, for a particular member-interest, the various interest scores may be represented as an interest vector. Accordingly, for several different member-intent scores, the various scores can be represented as a member interest and intent matrix, such as the example shown in FIG. 1B.

Referring again to FIG. 1A, for each different type or category of intent, one or more interest scores are provided, such as the model entities labelled as “INTEREST 1”, “INTEREST 2”, and “INTEREST 3”. The interest scores for each interest type or category provide a measure at a more granular level of insight into the particular interest that each member has with respect to a particular intent type or category. For example, if a particular member has a high member-intent score for the intent type of “job-seeker,” and a high member-interest score for the interest type of “software engineering,” there is a high likelihood that the member is interested in software engineering jobs. As such, the combination of an intent and interest score can provide detailed information about a member's application, service and content preferences. For instance, continuing with the example, when the particular member is presented with a landing or home page for the social networking service, because of his high job-seeker intent score, it would make sense to position a content module for an application or service relating to the job search function in a prominent position on the page. Moreover, because the member's interest score for software engineering is high, the content presented within the particular job search content module may be tailored to present to the particular member one or more job listings specifically related to software engineering positions. Accordingly, a member's intent and interest scores can be used in a process for selecting various content modules for different applications and services to present to a user. Furthermore, the individual application and service modules can personalize an experience for a member, for example, by selecting content to present based on intent and interest scores. For example, a content recommendation algorithm may leverage the intent and interest scores to select news articles and other content for presentation to a member. Similarly, a relevance or ranking algorithm of a search engine may provide personalized search results by ordering a set of search results based at least in part on how the search results relate to a member's intent and interest scores.

Generally, the input data with which the score-generating module determines or derives the member-intent and member-interest scores can be classified as being one of three different types of data. First, the data may be what is referred to as member profile data. Member profile data is personal data associated with a specific member (e.g., a registered user) of the social networking service, and is in essence a digital representation of a person's identity. Accordingly, member profile data typically consists of biographical information, including a person's name, birthdate, age, geographical location of residence, and so forth. With some social networking services, member profile data may also include a variety of education and career-oriented information commonly found in a resume or curriculum vitae. For instance, member profile data may include information about the schools (high school, college, university, graduate school, technical or vocational school, etc.) that a member has attended, or from which a member has graduated. Similarly, a member may indicate the concentration(s) of his or her academic studies, including any degrees or diplomas earned. In addition to information about a member's formal education, a member may include as part of his or her member profile, information about various positions of employment (e.g., job titles) that the member has previously held or currently holds, the name of any companies at which the member was or is currently employed, industries in which the member has been, or is, employed, any special achievements or rewards that the member has obtained, and/or any skills that the member has acquired or obtained. In some instances, a member may specify that he or she possesses various skills. Other members may take action to endorse a member generally, or some specific portion of a member's profile, such as the skills a member indicates that he or she possesses. Accordingly, skills and endorsement are also part of a member profile. Of course, a wide variety of other information may also be part of a member's member profile.

With some embodiments, member profile data includes not only the information that is explicitly provided by a member, but also a number of derived or computed attributes or components. For example, a member may not explicitly specify his or her tenure at his or her current position of employment, or his or her seniority level within a company or overall career. Nonetheless, based on the information that the member does provide, his or her tenure or seniority level may be inferred—that is, computed or derived from the available information. In yet another example, a member may not specify a particular industry in which the member is employed. However, using information about the company at which the member is employed, the specific industry may be inferred. Additionally, various member profile attributes may be pre-processed for the purpose of normalizing and/or standardizing certain member profile attributes, thereby enabling more meaningful analysis and comparisons to be performed. For example, a member-provided profile attribute specifying a member's job title in free text form may be standardized by mapping the member-provided job title to a corresponding standardized job title, based on various other factors, such as the industry of the company at which the member is employed. In many instances, the same or a similar job title may be used in different industries, such that the actual skills and responsibilities of two members are very different, despite those members having the same job title (e.g., consider the title, “analyst,” in the financial services industry, and information technology industry.) By standardizing the job titles of the members, more meaningful analysis and comparisons can be achieved.

With some embodiments, various computed or derived profile attributes may be automatically made part of a member's member profile with or without the member's explicit acknowledgment. In some instances, one or more attributes or components of a member's profile may not be viewable by the member and/or any other members. For instance, while many member-provided profile attributes or components may be viewable by the public, or persons within the member's social network, depending upon the particular access privileges or settings established by the member, in some instances, various attributes or components of a member's profile may not be viewable by others. For instance, a derived member profile attribute indicating a member's seniority level may not be viewable by the member or any other members.

Another type of data that is available to the score-generating module for use as input data and from which the score-generating module can determine or derive the various intent and interest scores is referred to generally as social graph data. Generally, social graph data is data identifying or otherwise indicating the relationships and associations that a member has with other members, and other entities (e.g., companies, schools, groups, etc.) represented in a social graph maintained by the social networking service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities. Although other techniques may be used, with some embodiments the social graph data structure is implemented with a special type of database known as a graph database. Accordingly, if a member is employed at a particular company, this particular association will be reflected in the social graph. Similarly, when a member joins a particular online group hosted by the social networking service, or hosted by a third-party service provider, the member's membership in the group may be reflected in the social graph data.

Analysis of social graph data may signal a member's intentions, and therefore may be used to derive a score representing a particular type of intent for a member. For instance, with some embodiments, by analyzing certain social graph data, the score-generating module can identify certain signals that are highly suggestive of active job-seeking activity. For example, members who are actively seeking jobs may be more likely to follow other members of the social networking service, or establish new connections with other members in a very concentrated or shortened time span—particularly other members who are job recruiters, or who are associated with a job recruiting function. Similarly, members who are actively seeking jobs may be more likely to follow certain companies at which there are open job positions matching the member's skills, or having the same job title as currently held by the member. Members who are actively seeking jobs may be more likely to join certain online groups—particularly those groups that exist primarily to aid job seekers. Accordingly, by analyzing social graph data to identify the entities with which a member is establishing associations or connections, and the timing and frequency of the activity, the job-seeking intentions of a member may be inferred, and used in the derivation of a metric representing the member's job-seeking intent.

With some embodiments, the number of connections that a member has may provide some insight into the likelihood that the member will establish new connections, and thus be useful in representing a connector intent score. Some other examples of how social graph data are used to derive a metric representing a particular type of intent involve analyzing the activity of other members that belong to, or are otherwise associated with, some entity with which the particular member is also associated. For instance, if the social graph information indicates that an unusually large number of employees of a particular company have recently departed, this may reflect an underlying issue with the vitality of the company, and thus be reflected in the particular member's job-seeking score. In particular, if the social graph data indicates that a large number of people have recently left the company at which the particular member is employed, this will have the effect of increasing the job-seeker scores for members of the social networking service who are employed at the company. Similarly, if the social graph data indicates a recent surge in the overall number of employees at a particular company, this may reflect desirability of the members to work at the company, and thus decrease the job-seeker intent score of current employees of the company. With some embodiments, the activity of other members who are similarly associated with a particular entity may also have an effect on member's intent score. For instance, if an unusually high number of employees at a particular company are actively submitting search queries to a job-related search engine, actively communicating via the social networking service with other members who are job recruiters, and/or actively submitting job applications for employment positions at other companies, these activities of other members in the particular member's social graph may have an effect on the particular member's job-seeker intent score. Of course, similar analysis may be performed for any one of the other intent scores.

Finally, a third type of input data that may be used by the score-generating module to determine the intent and interest scores for a member is data referred to herein as member-activity and/or behavioral data. Member-activity and behavioral data is data obtained by monitoring and tracking the interactions that a member has with various applications, services and/or content that are provided by, or, integrated or otherwise associated with, the social networking service. For example, a social networking service may provide any number and variety of applications and/or services with which a member interacts. Similarly, a variety of third-party applications and services may leverage various aspects of the social networking service, for example, via one or more application programming interfaces (APIs). A few examples of such applications or services include: search engine applications and services, content sharing and recommendation applications (e.g., photos, videos, music, hyperlinks, slideshow presentations, articles, etc.), job posting and job recommendation applications and services, calendar management applications and services, contact management and address book applications and services, candidate recruiting applications and services, travel and itinerary planning applications and services, and many more. For any one of the aforementioned applications, interactions may be detected via any number of channels.

Each of these applications and/or services may have a variety of interfaces via which a member can interact with the application or service. For example, when a member selects various links or content on a web page, these interactions may be detected and logged, along with the time at which the interactions occurred, and various contextual information about the interactions, to include a type, category or some other classification of the subject matter to which the interactions relate. In addition to interacting via a web page, various other interactions may be detected and logged, to include interactions with an application or service via a mobile application, as well as email and other messaging applications. Accordingly, both the type of interaction (e.g., search performed, page viewed, job listing viewed) and the subject matter of the content with which the interaction occurred provide insight into both the member's intent and interests.

By detecting how and when members interact with such applications and services, relevant data signals can be inferred from the data and used as input to the score-generating module in deriving one or more intent scores, and/or interest scores. For example, with some embodiments, a social networking service may provide or be associated with one or more job posting and job recommendation applications or services. The frequency and nature of interactions that a member has with the various content modules of the job posting and recommendation applications and services may be used to infer a member's job-seeking intent score or recruiting intent score. Similarly, the nature of the particular content with which a member interacts may be used in determining an interest score.

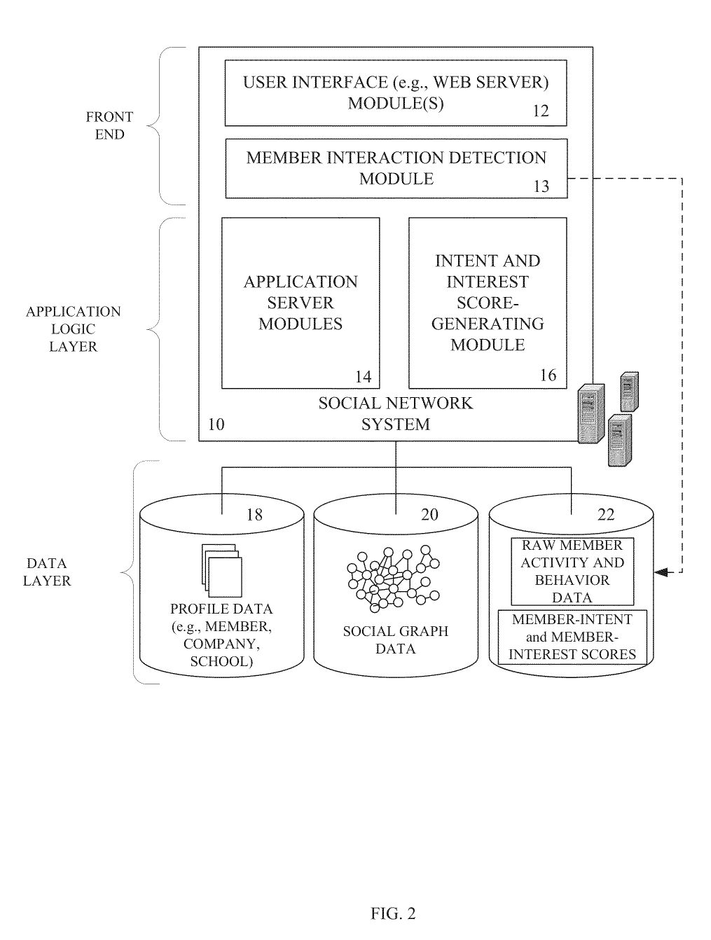

FIG. 2 is a block diagram showing the functional components of a social networking service, including a data processing module referred to herein as an intent and interest score-generating module 16 (or, simply score-generating module), for use in determining various intent and interest scores for members of the social networking service, consistent with some embodiments of the invention. As shown in FIG. 2, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. In addition, a member interaction and detection module 13 is provided to detect various interactions that members have with different applications, services and content presented. As shown in FIG. 2, upon detecting a particular interaction, the detection module 13 logs the interaction, including the type of interaction and any meta-data relating to the interaction, in the activity and behavior database with reference number 22.

The application logic layer includes various application server modules 14, which, in conjunction with the user interface module(s) 12, generates various user interfaces (e.g., web pages) with data retrieved from various data sources in the data layer. With some embodiments, individual application server modules 14 are used to implement the functionality associated with various applications and/or services provided by the social networking service.

As shown in FIG. 2, the data layer includes several databases, such as a database 18 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 18. Similarly, when a representative of an organization initially registers the organization with the social networking service, the representative may be prompted to provide certain information about the organization. This information may be stored, for example, in the database with reference number 18, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within the social graph, shown in FIG. 2 with reference number 20.

As members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 2 by the database with reference number 22. This logged activity information is then used by the intent and interest score-generating module 16 to derive various intent scores and interest scores for members. With some embodiments, once the various scores are computed for a member, the scores are stored in association with a member's identifier (e.g., a unique member identifier) and made available to a wide variety of applications and services. In some instances, the scores are made available, for example, via an application-programming interface (API).

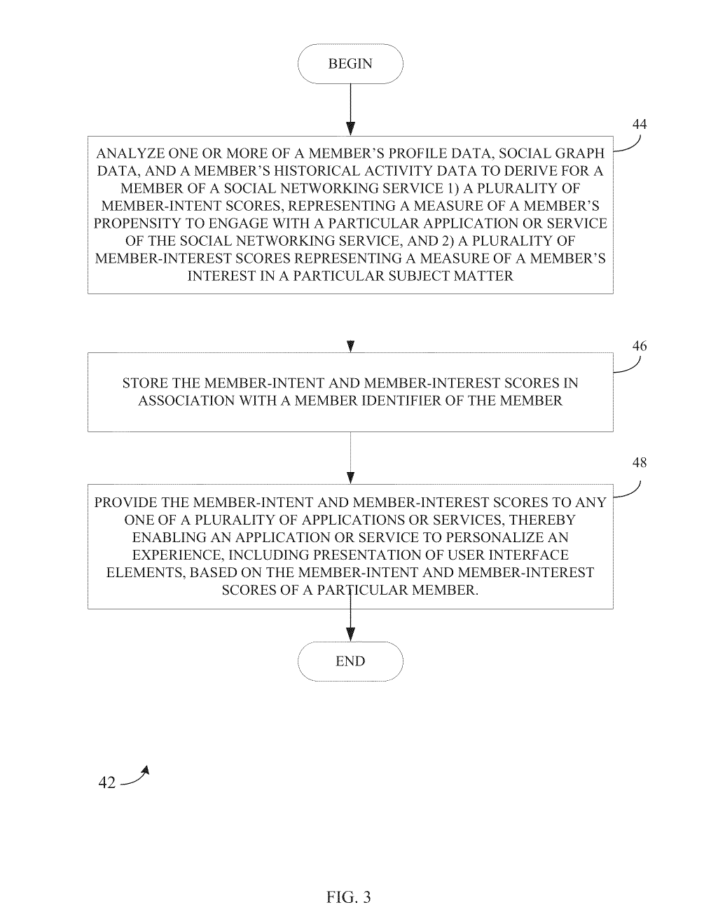

As illustrated in FIG. 2, the intent and interest score-generating module 16 receives, as input, data from any one or more of the databases 18, 20 and 22, and computes or derives for each member of the social networking service a set of intent and interest scores. With some embodiments, the scores are generated periodically, based on some predefined schedule. Alternatively, with some embodiments, the scores for a member may be generated in real-time, for example, responsive to a request to generate the scores for the member. With some embodiments, one or more intent scores or interest scores may be based in part on the number of times that a particular member performed some specific action within a particular range of time. However, in some instances, certain data used in deriving an intent or interest score may be subject to a time decay algorithm, such that the contribution of the particular data element to any particular score may depend on the time when the data was generated—or more precisely, the time when a user took some particular action. The operation of the score-generating module is described in greater detail below in connection with the description of FIG. 3.

Although not shown, with some embodiments, the social networking system 10 provides an application programming interface (API) module via which applications and services can access various data and services provided or maintained by the social networking service. For example, using an API, an application may be able to request one or more intent and interest scores for a particular member identified by a member identifier. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the members' intent and interest scores available to third party applications and services.

FIG. 3 is a flow diagram showing the method operations of a method for determining various member-intent and member-interest scores for a member of a social networking service, consistent with some embodiments of the invention. As illustrated in FIG. 3, at method operation 44, a score-generating module analyzes one or more of a member's profile data, social graph data, and historical activity data to derive a set of member-intent scores and member-interest scores. Each intent score and each interest score is derived based on its own algorithm specifying a combination of input data for deriving the intent or interest score. Accordingly, the score-generating module may compute any number of intent scores with associated interest scores. With some embodiments, the intent and interest scores are derived as a weighted combination of the count of certain user-initiated activities or behaviors that have been detected and logged, where the count is subject to some timing parameters. For example, the contribution of any given activity to the overall score may depend on when that activity occurred, such that, generally, activities having occurred in the distant past will contribute less to an overall score than similar activities that have recently been detected. With some embodiments, the weighting factors for any particular detected activity or behavior may be established via a supervised machine learning algorithm.

Once derived, the set of intent and interest scores are stored in association with a member identifier of a member, as indicated at method operation 46. Finally, at method operation 48, the scores are made available to any number and variety of applications and services, enabling those applications and services to personalize a user experience, particularly the presentation (selection, arrangement, format, and so forth) of various user interface elements, based on the member's intent and interest scores.

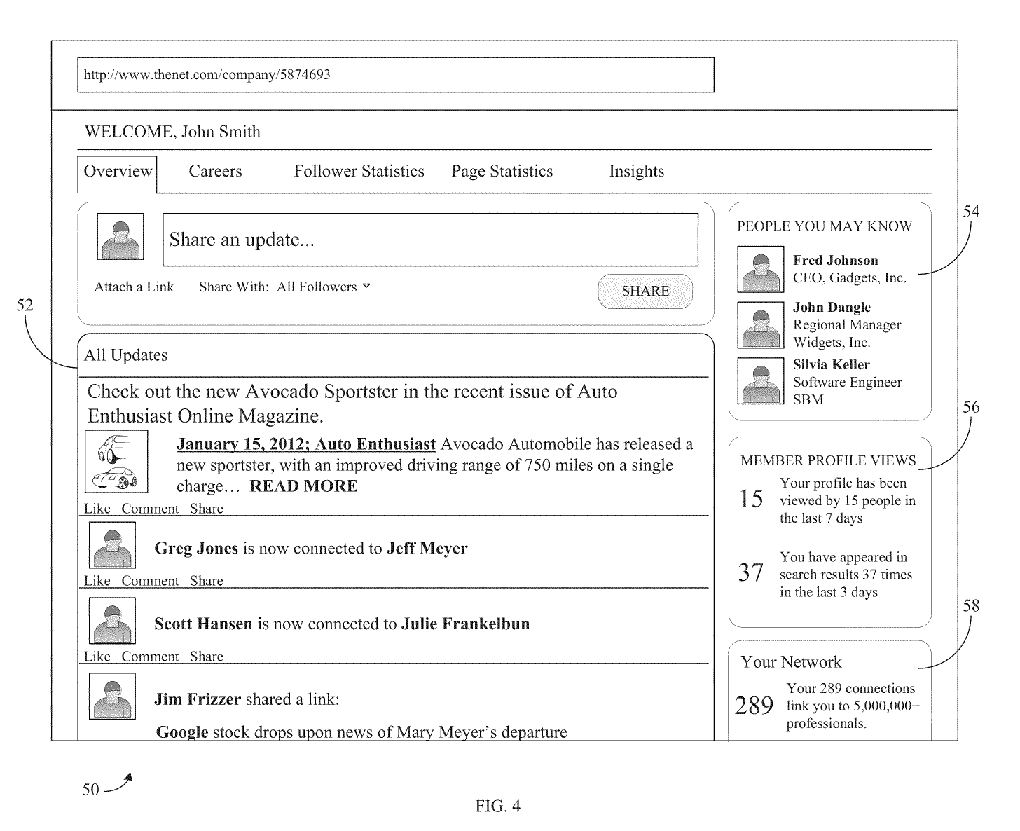

FIG. 4 illustrates an example user interface 50 for a social networking service, with an activity or content stream 52, and several content modules 54, 56, and 58, consistent with some embodiments of the invention. As illustrated in FIG. 4, a personalized page is being presented to a member of the social networking service, with the name, John Smith. In this example, several of the user interface elements have been selected based on various member-intent and interest scores. For instance, the content modules 54, 56 and 58 have been selected from a large number of content modules for presentation to the member. Similarly, the ordering of the content items in the activity or content stream 52 may be based in part on one or more intent and/or interest scores. The tabs shown in the navigation bar can be tailored or personalized for the member, based on his intent and interest scores. With some embodiments, when a member performs a search for other members, the intent and interest scores of those members may be used as search targeting criteria. Skilled artisans will readily appreciate that any number and variety of applications and services may leverage the members' intent and interest scores to achieve a variety of objectives. As described immediately below, a few general objectives that may be achieved with intent and interest scores are 1) personalization and/or customization of a member's experience, and 2) targeting and search for members.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

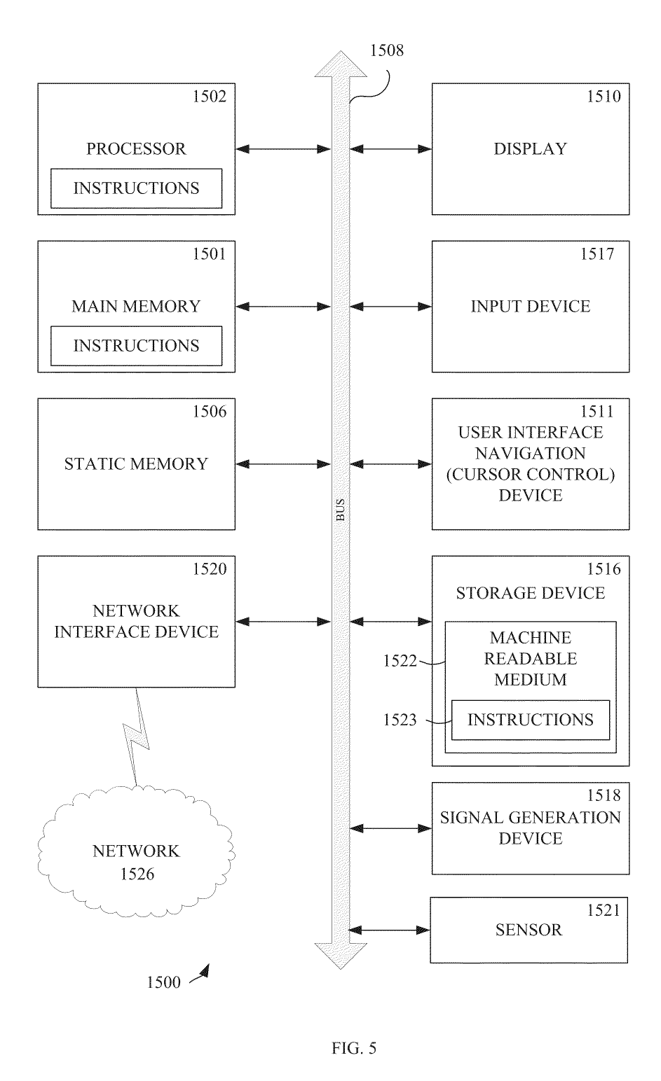

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method comprising:
with a processor-based score-generating module, analyzing one or more of profile data, social graph data, and historical activity data of a member of a social networking service to derive for the member i) a plurality of member-intent scores, with each member-intent score representing a measure of the member's propensity to engage with a particular application or service of the social networking service, and ii) a plurality of member-interest scores for each member-intent score, with each member-interest score representing a measure of a member's interest in a particular subject matter as that subject matter relates to a particular member intent score; and
storing the plurality of member-intent scores and the corresponding member-interest scores in association with a member identifier of the member.

2. The method of claim 1, wherein each member-intent score is derived with a separate algorithm that specifies the particular combination of a member's profile data, social graph data, and a member's activity data to be used in deriving a member-intent score.

3. The method of claim 1, wherein each member-interest score is derived with a separate algorithm that specifies the particular combination of a member's profile data, social graph data, and a member's activity data to be used in deriving a member-interest score.

4. The method of claim 1, wherein each member-interest score represents a measure of a member's interest in a particular subject matter, for a particular member-intent type.

5. The method of claim 1, wherein at least one of the member-intent scores of the plurality of member-intent scores is a job-seeker intent score representing a measure of a member's propensity to engage with an application, service or content that may facilitate a change in jobs.

6. The method of claim 5, wherein a member-interest score associated with a job-seeker intent score represents a measure of a member's interest in a job of a particular type.

7. The method of claim 1, wherein at least one of the member-intent scores of the plurality of member-intent scores is a recruiter intent score representing a measure of a member's propensity to engage with an application, service or content that relates to or facilitates recruitment of members for employment positions.

8. The method of claim 7, wherein a member-interest score associated with a recruiter intent score represents a measure of a member's interest in recruiting other members for jobs of a particular type.

9. The method of claim 1, wherein at least one of the member-intent scores of the plurality of member-intent scores is a connector intent score representing a measure of a member's propensity to engage in activity resulting in connections with other members of the social networking service.

10. The method of claim 9, wherein a member-interest score associated with a recruiter intent score represents a measure of a member's interest in recruiting other members for jobs of a particular type.

11. The method of claim 1, wherein at least one of the member-intent scores of the plurality of member-intent scores is a subscription-user intent score representing a measure of a member's propensity to subscribe to a premium membership account.

12. A system comprising:
at least one memory device storing instructions executable by one or more processors;
at least one processor for executing instructions stored in the at least one memory device;
a score-generating module, implemented by the processor, to analyze one or more of profile data, social graph data, and historical activity data of a member of a social networking service to derive for the member i) a plurality of member-intent scores, with each member-intent score representing a measure of a member's propensity to engage with a particular application or service of the social networking service, and ii) a plurality of member-interest scores for each member-intent score, with each member-interest score representing a measure of a member's interest in a particular subject matter as that subject matter relates to a particular member intent score;
wherein the plurality of member-intent scores and the corresponding member-interest scores are stored in the at least one memory device in association with a member identifier of the member.

13. The system of claim 12, wherein each member-intent score is derived with a separate algorithm that specifies the particular combination of a member's profile data, social graph data, and a member's activity data to be used in deriving a member-intent score.

14. The system of claim 12, wherein each member-interest score is derived with a separate algorithm that specifies the particular combination of a member's profile data, social graph data, and a member's activity data to be used in deriving a member-interest score.

15. The system of claim 12, wherein each member-interest score represents a measure of a member's interest in a particular subject matter, for a particular member-intent type.

16. The system of claim 12, wherein at least one of the member-intent scores of the plurality of member-intent scores is a job-seeker intent score representing a measure of a member's propensity to engage with an application, service or content that may facilitate a change in jobs.

17. The system of claim 16, wherein a member-interest score associated with a job-seeker intent score represents a measure of a member's interest in a job of a particular type.

18. The system of claim 12, wherein at least one of the member-intent scores of the plurality of member-intent scores is a recruiter intent score representing a measure of a member's propensity to engage with an application, service or content that relates to or facilitates recruitment of members for employment positions.

19. The system of claim 18, wherein a member-interest score associated with a recruiter intent score represents a measure of a member's interest in recruiting other members for jobs of a particular type.

20. The system of claim 12, wherein at least one of the member-intent scores of the plurality of member-intent scores is a connector intent score representing a measure of a member's propensity to engage in activity resulting in connections with other members of the social networking service.

21. The system of claim 20, wherein a member-interest score associated with a recruiter intent score represents a measure of a member's interest in recruiting other members for jobs of a particular type.

22. The system of claim 12, wherein at least one of the member-intent scores of the plurality of member-intent scores is a subscription-user intent score representing a measure of a member's propensity to subscribe to a premium membership account.
